(19) United States
(12) Patent Application Publication
(10) Pub. No.: US 2011/0131139 A1
(43) Pub. Date: Jun. 2, 2011

(54) INTEGRATED EARNED VALUE MANAGEMENT WORKFLOW

(75) Inventors: John L. Gregory, Austin, TX (US); Michael P. Lee, Sterling, VA (US)

(73) Assignee: International Business Machines Corporation, Armonk, NY (US)

(21) Appl. No.: 12/628,670

(22) Filed: Dec. 1, 2009

(51) Int. Cl. G06Q 10/00

(52) U.S. Cl. 705/301

(57) ABSTRACT

The present invention relates to a method or system for automating consolidation of data for reporting purposes, decreasing manual user intervention, and automating the generation of earned value management documentation using a custom designed matrix that is role-based having four (4) fundamental workflow processes: post-award, work authorization, change request, and variance analysis reporting. One method may have the steps of consolidating control accounts between an integrated master schedule and an earned value management system, automatically generating work authorizations and corresponding workflow, integrating baseline change requests and follow-on work authorization, generating and organizing, in a hierarchical manner, variance analysis reports, and organizing, in a streamlined manner, finalized earned value management documentation.

### FIELD OF THE INVENTION

The present invention relates to a method or system for automating consolidation of data for reporting purposes, decreasing manual user intervention, and automating the generation of earned value management documentation using a custom designed matrix that is role-based having four fundamental workflow processes: post-award, work authorization, change request, and variance analysis reporting.

### BACKGROUND OF THE INVENTION

Earned value management (EVM) is a very labor and document intensive process. Earned value management is a technique for objectively measuring project performance by combining the measurement of project scope, schedule and cost into one single integrated metric. Businesses and other enterprises must comply with strict standards (e.g., ANSI-748) set forth by the Department of Defense and their programs and related projects can be subject to audit at any time. The ANSI-748 Standard contains earned value management systems (EVMS) guidelines and common terminology that are the normative content. it also contains earned value management systems process discussion, system documentation, and system evaluation sections that are informative sections providing application and implementation insight. Data may be dispersed across multiple tools and databases, which makes consolidation for reporting purposes cumbersome. Although workflow exists for the generation of contract briefs, work authorization documents, change requests, and variance analysis reports, for the most part, it is entirely paper-based. Each document requires signatures, and information has historically resided in various separate locations. Throughout the life-cycle of a program, documentation can fill multiple 3-ring binders and it can often be difficult to find required information. Automation of workflow is needed to limit manual user interaction as much as possible, thus providing greater control over process and methodology.

In prior art systems, the public sector earned value management PMO attends the only major earned value management global conference annually and keeps up to date with the latest trends in this highly-specialized practice. A project management office (PMO) in a business or professional enterprise is the department or group that defines and maintains the standards of process, generally related to project management, within the organization. There are no known solutions that implement automated workflow with data consolidation to streamline and simplify earned value management procedure and ANSI-748 compliance.

These are the most time-consuming processes on earned value contracts, and satisfying these goals will greatly reduce time spent on administration, increase data accuracy, and significantly improve productivity.

There is a need to automate the consolidation of data for reporting purposes, decrease manual user intervention and thus error, and automate the generation of earned value management documentation.

Therefore, there is a need to solve the problems associated as described above.

### SUMMARY OF THE INVENTION

The method and system of the present invention may automate consolidation of data for reporting purposes, decreasing manual user intervention, and automating the generation of earned value management documentation using a custom designed matrix having four fundamental workflow processes: post-award, work authorization, change request, and variance analysis reporting.

The present invention provides a custom solution that delivers such functionality as automated electronic form-based workflow for contract briefs, work authorization documents (WADs), also called work authorization forms, baseline change requests, and variance analysis reports and streamlined variance analysis reporting with roll-ups by program, month, and control account manager.

The present invention provides a method for automating consolidation of data for reporting purposes, decreasing manual user intervention, and automating the generation of earned value management documentation custom designed matrix in a system, the method may have such steps as consolidating control accounts between an integrated master schedule and an earned value management (EVM) system, automatically generating work authorizations and corresponding workflow, integrating baseline change requests and follow-on work authorization, generating and organizing, in a hierarchical manner, variance analysis reports, organizing, in a streamlined manner, finalized earned value management documentation, scanning the integrated master schedule for work breakdown structure identifiers (IDs) that correspond to control account IDs in the earned value management system, automatically generating electronic work authorization forms, linking the electronic work authorization forms and sending the electronic work authorization forms, automatically pulling in budget data from the earned value management system as well as period of performance data into the electronic work authorization forms, guiding project controls through the process of revising and authorizing work via the earned value management system and workflow system, or automatically generating a new “incremented” entry in a control account matrix for additional work and listing each revision of an existing control account in the control account matrix along with its baseline change request number, generating variance analysis reports in a custom-designed hierarchical user portal based on a combination of the control accounts for which work authorization has been approved and whether or not monthly and cumulative cost and schedule variance thresholds of the control accounts have been tripped, automatically finalizing, locking down, and storing process approved documents in program-specific document repositories at the end of each workflow.

The present invention may further provide a system for automating consolidation of data for reporting purposes, decreasing manual user intervention, and automating the generation of earned value management documentation custom designed matrix in a system, the system may have a consolidating control accounts component for consolidating control accounts between an integrated master schedule and an earned value management (EVM) system, a work authorizations and corresponding workflow generating component for automatically generating work authorizations and corresponding workflow, an integrating component for integrating baseline change requests and follow-on work authorization, a report generating and organizing component for generating and organizing, in a hierarchical manner, variance analysis reports, an earned value management documentation organizing component for organizing, in a streamlined manner, finalized earned value management documentation, a scanning component for scanning the integrated master schedule for work breakdown structure IDs that correspond to control account ids in the earned value management system, a forms and links generator for automatically generating electronic work authorization forms linking the electronic work authorization forms and sending the electronic work authorization forms and a control account matrix for storing additional work and listing each revision of an existing control account in the control account matrix along with its baseline change request number.

The present invention may further provide a computer program product embodied in a computer readable medium for operating in a system comprising a processing unit, a memory, a bus, input/output (I/O) interfaces, an application, the computer program product for implementing a method in a system for automating consolidation of data for reporting purposes, decreasing manual user intervention, and automating the generation of earned value management documentation custom designed matrix, the method having the steps of consolidating control accounts between an integrated master schedule and an earned value management (EVM) system, automatically generating work authorizations and corresponding workflow, integrating baseline change requests and follow-on work authorization, generating and organizing, in a hierarchical manner, variance analysis reports, organizing, in a streamlined manner, finalized earned value management documentation, scanning the integrated master schedule for work breakdown structure identifiers (IDs) that correspond to control account IDs in the earned value management system, automatically generating electronic work authorization forms, linking the electronic work authorization forms and sending the electronic work authorization forms. automatically pulling in budget data from the earned value management system as well as period of performance data into the electronic work authorization forms, and guiding project controls through the process of revising and authorizing work via the earned value management system and workflow system, or automatically generating a new “incremented” entry in a control account matrix for additional work and listing each revision of an existing control account in the control account matrix along with its baseline change request number.

The present invention may further provide for a method for deploying a computing infrastructure comprising integrating computer-readable code into a computing system, wherein the code in combination with the computing system is capable of performing a process for automating consolidation of data for reporting purposes, decreasing manual user intervention, and automating the generation of earned value management documentation custom designed matrix, the process having such steps as consolidating control accounts between an integrated master schedule and an earned value management (EVM) system, automatically generating work authorizations and corresponding workflow, integrating baseline change requests and follow-on work authorization, generating and organizing, in a hierarchical manner, variance analysis reports and organizing, in a streamlined manner, finalized earned value management documentation.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a data processing system suitable for implementing an embodiment of the present invention.

FIG. 2 shows a network for implementing an embodiment of the present invention.

FIG. 3 illustrates an embodiment of a method of the present invention.

FIG. 4 illustrates an embodiment of a system of the present invention.

FIG. 5 illustrates another embodiment of a system of the present invention.

The drawings are merely schematic representations, not intended to portray specific parameters of the invention. The drawings are intended to depict only typical embodiments of the invention, and therefore should not be considered as limiting the scope of the invention.

### DETAILED DESCRIPTION OF THE INVENTION

The present invention comprises a system and methods for automating consolidation of data for reporting purposes, decreasing manual user intervention, and automating the generation of earned value management documentation using a custom designed matrix. the present invention may have four (4) fundamental workflow processes: post-award, work authorization, change request, and variance analysis reporting.

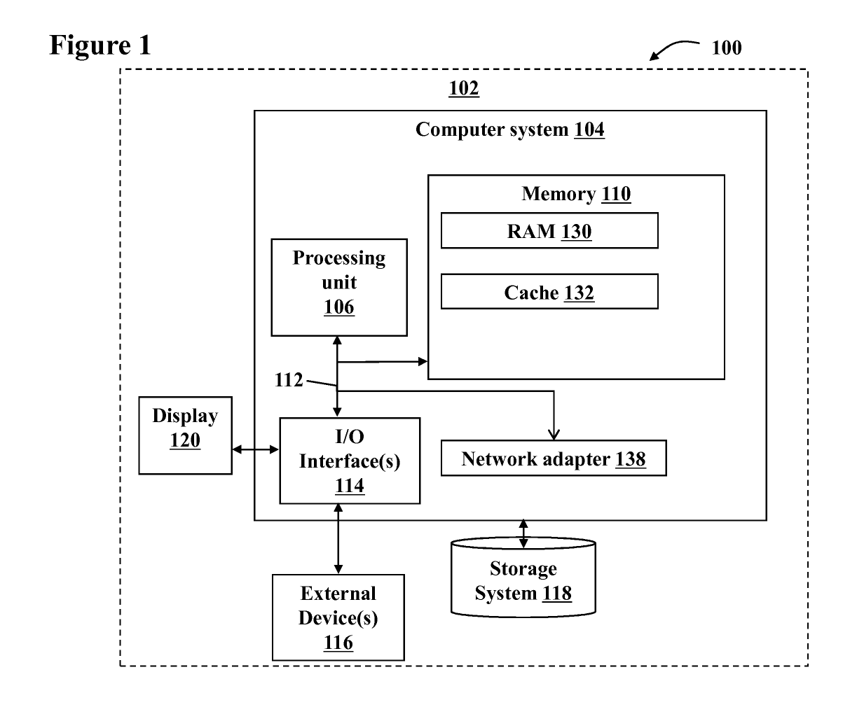

FIG. 1 shows a system 100 that may have a data processing system 102 suitable for implementing an embodiment of the present invention. Data processing system 102 may have a computer system 104 connected to a display 120, external device(s) 116 and video camera 140 or other peripheral devices for providing a user an interface to computer system 140 being connected via I/O interface(s) 114. Computer system 104 may have an internal bus 112 for providing internal communication between such modules as processing unit 106, I/O interface(s) 114, network adapter 138 and memory 110. Memory 110 may have random access memory (RAM) 130, cache 132 and storage system 118 or other forms of memory. RAM may take the form of integrated circuits that allow stored data to be accessed in any order, that is, at random. Storage system 118 may take the form of tapes, magnetic discs and optical discs and are generally used for long term storage of data. Cache 132 is a memory for storing a collection of data-duplicating original values stored elsewhere or computed earlier, where the original data is expensive to fetch (owing to longer access time) or to compute, compared to the cost of reading the cache. In other words, a cache is a temporary storage area where frequently accessed data can be stored for rapid access. Once the data is stored in the cache, it can be used in the future by accessing the cached copy rather than re-fetching or re-computing the original data. A cache has proven to be extremely effective in many areas of computing because access patterns in typical computer applications have locality of reference.

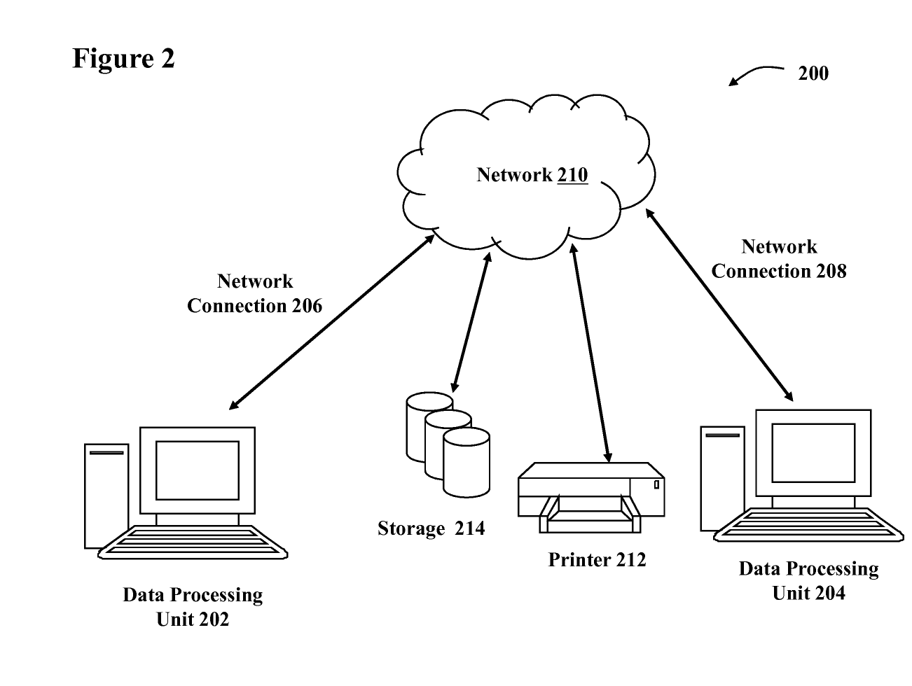

FIG. 2 shows a network system 200 for implementing an embodiment of the present invention. Network system 200 may have a network 210 or group of interconnected computers, such as data processing units 202, 204, via network connections 206, 208 and may be of the type, e.g., a local area network (LAN) or internetwork. Printer 212 and storage 214 may be connected to network 210 via network connections 216, 218. Basic network components may include network interface cards, repeaters, hubs, bridges, switches and routers. Data processing units 202, 204 may be computers such as web servers or personal computers, or other user agents. A web server generally has hardware and software that are responsible for accepting HTTP requests from clients (user agents such as web browsers), and serving them HTTP responses along with optional data contents, which usually are web pages such as HTML documents and linked objects (images, etc.). In this document, the term “web browser” is used but any application for retrieving, presenting, and traversing information resources on the Internet must be considered.

Following a contract award, such as from the United States Department of Defense, a responsibility assignment matrix (RAMatrix) must be developed by a company or other business enterprise. According to a solution deployment descriptor (SDD), a responsibility assignment matrix sets organizational responsibility for work delineated in the work breakdown structure. A work breakdown structure (WBS) in project management and systems engineering, is a tool used to define and group a project's discrete work elements (or tasks) in a way that helps organize and define the total work scope of the project. The responsibility assignment matrix illustrates the work assigned to each project organizational element to ensure that all effort is identified and has a responsible organizational element specified to perform it. As such, the responsibility assignment matrix is a matrix depicting the organizational breakdown structure on one axis and the work breakdown structure on the other. Organizational breakdown structure (OBS) is a global hierarchy that represents a different levels of responsible with in a project or enterprise. The organizational breakdown structure usually reflects the management structure of an organization, from top-level personnel down through the various levels constituting a business. In addition, the responsibility assignment matrix ensures that each organizational element or manager knows the work for which they are responsible and the chain of command within the organization.

The Post-Award Workflow may not generate a responsibility assignment matrix. The responsibility assignment matrix template may be provided, however, when the program earned value management systems document library is created as a result of publishing an IMS (program plan/schedule) proposal. This template will be used to specify control accounts for their respective elements in the program schedule. It will be used by the master scheduler to update the plan in project server once a contract brief (CB) has been generated.

A specific process of the present invention may be followed by the post-award workflow to ensure that a contract brief and project authorization document (PAD) are generated and approved.

1. An earned value management systems administrator may open a project plan (IMS) in a software product such as Microsoft Project Professional. Microsoft Project Professional is a trademark or registered trademark of Microsoft Corporation.

2. Project workflow properties are accessed by, for instance, the user clicking on an “open” button on a user interface by using a mouse button.

3. Once an valid microframe program manager username and password are input, a list of microframe program manager projects may now be available in the microframe program manager project ID dropdown menu.

4. A microframe program manager project ID related to this schedule is then selected.

5. A project controls manager, program manager (PM) and contracts manager may then be selected.

6. After the project plan status is changed to “Active”, the project is published.

7. On publishing the project, the following events may happen in the background: A workspace may be created that may be used for collaboration on the project. This workspace may also contain finalized workflow documents (e.g., contract briefs, work authorization documents or forms, baseline change requests, and variance analysis reports (VARs). A contract brief may be generated for the project, and the project controls manager may be sent a message requiring the initialization of a contract brief and, if necessary, a project authorization document.

8. The project controls manager may then be automatically e-mailed a message with a link to the contract brief.

9. The project controls manager may then click on an “Access Contract Brief” button on a user interface and then on “Open” button and a web form for the contract brief will automatically be accessed and displayed in a new window.

At the completion of the post-award process, a contract brief and, if applicable, a project authorization document are stored in an InfoPath form library for the related project/program. Microsoft Office InfoPath is an application used to develop XML-based data entry forms. “Microsoft”, “Office” and “InfoPath” may be trademarks or registered trademarks of Microsoft Corporation. Microsoft Office InfoPath is used as merely an example of an application used to develop XML-based data entry forms and not necessarily required to implement the present invention. Once this has happened, the master scheduler may open the project plan in the project plan software product and assign a control account manager (CAM) and functional manager to each work breakdown structure element associated with a control account. These assignments will be used to generate work authorization documents.

Authorization of the performance of work in a program schedule is handled by work authorization documents. The work authorization document or form allows work to be planned and for effort to begin. A single work authorization document is prepared and issued for each control account, thus requiring the approval and review by a control account manager. An approved work authorization document requires signatures by the project manager, the functional manager (unless the project manager is the functional manager, in which case only the project manager signature is required) and the control account manager. As such, the work authorization document serves as an in-house contract between the responsible parties. Project controls manager reviews and approves the work authorization documents as verification that the budget and schedule are consistent with the overall contract budget base. A specific process will be followed by the work authorization workflow to ensure that work authorization documents are generated and approved.

Periodically during the course of a program, the need to initiate a change request will arise. Change requests can be either internal or external.

Internal change requests are normally initiated by a control account manager, with help from project controls. Details of the change are documented through baseline change requests (BCRs).

Depending on the type of change, project controls will prepare necessary revised work authorization documents and revised project documentation such as work breakdown structure, organizational breakdown structure, responsibility assignment matrix, IMS (program plan/schedule) and subsidiary schedules, control accounts, work packages, planning packages, summary level planning packages, etc.

External change requests involve revisions to the original contract that are recognized and approved by the customer. Contract changes authorize a change in the scope of work or schedule and normally result in a dollar change in the contract budget base. All changes authorized by the customer must be supported by formal documentation (a contract brief) before being authorized via a project authorization document/work authorization document and entered into the system as an adjustment to the baseline.

The earned value management systems workflow will handle external change requests as part of two possible scenarios:

1. The contract change involves a completely new piece of work. This will require the generation of a new set of work breakdown structure elements and associated work authorization document approvals.

2. A revision of period and/or budget is required for work breakdown structure elements of existing work. the program schedule must be revised and existing work authorization documents updated. A specific process will be followed by the change request workflow to ensure that baseline change requests are generated and approved.

According to the IBM Earned Value Management Systems SDD (System Description Document), as an example, the earned value management system identifies those control accounts wherein variances (e.g., schedule variance, cost variance, and variance at completion) have exceeded pre-established thresholds at the close of the reporting period. IBM is a registered trademark for International Business Machines Corporation. Reports are generated for accounts where thresholds have been exceeded. These reports provide the control account managers with information to prepare their variance analysis reports (VARs). This process provides the means for higher-level management to monitor progress and follow up on corrective action plans. Variance analysis reports are automatically generated by the microframe program manager system. The automated earned value management systems workflow solution simplifies the process of breaking down the variance analysis reports by control accounts, allowing control account managers to update those areas for which they are responsible for. The solution also allows system administrators and project controls managers to consolidate all responses into a single report. A specific process will be followed by the work authorization workflow to ensure that variance analysis reports are generated and approved.

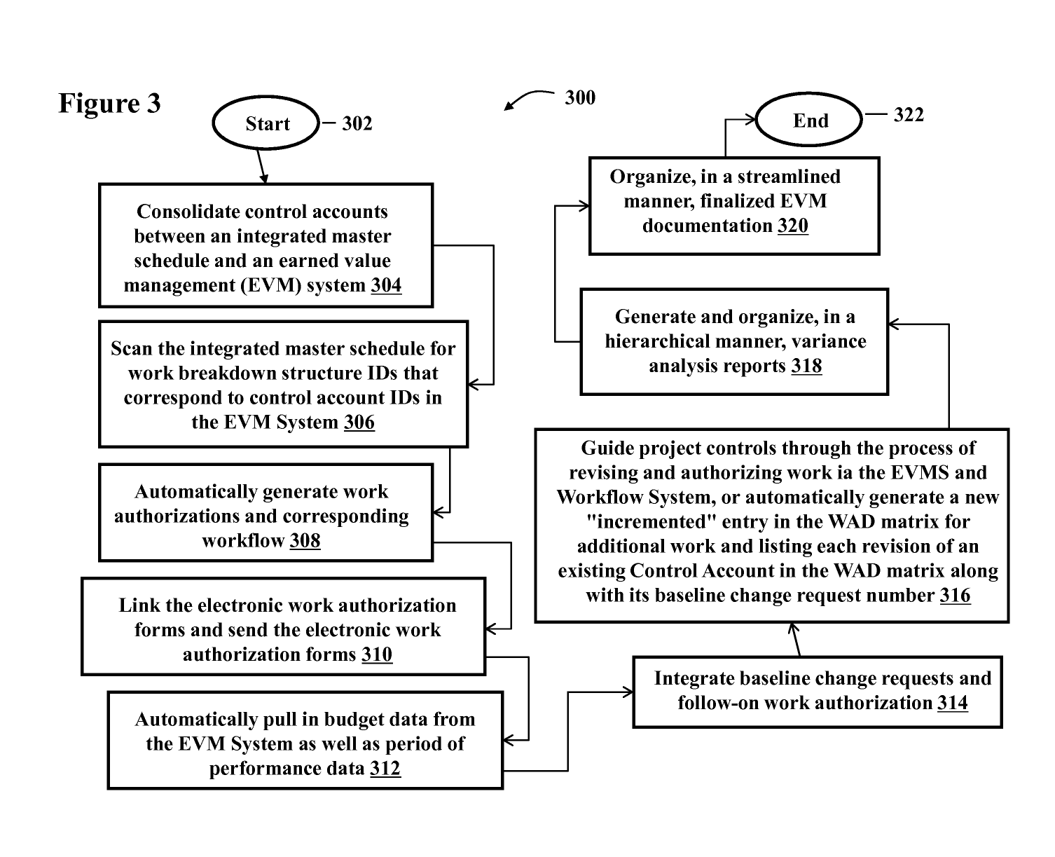

Some of the unique features of the integrated earned value management workflow of the present invention are shown in FIG. 3 in method 300 that starts at step 302:

1. Consolidation of control accounts between an integrated master schedule and an earned value management system where, at step 304, the control accounts are consolidated between an integrated master schedule and an earned value management system. The system and method of the present invention allows for scanning an integrated master schedule for work breakdown structure IDs that correspond to control account IDs in the earned value management system at step 306. This may include both a direct match and all work breakdown structure sub-levels. For sub-levels, early start and late finish dates are rolled up to the control account level to provide an accurate period of performance for the control account. All accounts are listed in a custom-designed matrix/user portal for the purpose of streamlined work authorization.

2. Automated generation of work authorizations and corresponding workflow where, at step 308, work authorizations and corresponding workflow are automatically generated. Using the system and method of the present invention, project controls managers can scan through a control account matrix (also called the “work authorization document center”) to select control accounts for which work should be authorized. With the click of a button, electronic work authorization forms may be automatically generated and links to these forms may be sent to the responsible control account managers at step 310, thus initiating a chain of approvals/rejections for the specified control account. Each work authorization form may also automatically pull in budget data from the earned value management system as well as period of performance rolled up from the scan of the integrated master schedule at step 312, mentioned above.

3. Integration of baseline change requests and follow-on work authorization where, at step 314, baseline change requests and follow-on work authorization are integrated. After baseline change requests have been submitted and approved by all responsible parties (via automated workflow), the system and method of the present invention may either guide project controls through the process of revising and authorizing work via the earned value management system and workflow system, or automatically generate a new “incremented” entry in the work authorization document matrix for additional work at step 316. Each revision of an existing control account may be listed in the work authorization document matrix along with its baseline change request number. This allows simplified tracking of the complete change history for a control account as well as its related change request approval process.

4. Hierarchical organization and generation of variance analysis reports where, at step 318, variance analysis reports are generated and organized in a hierarchical manner. Based on a combination of the control accounts for which work authorization has been approved and whether or not their monthly and cumulative cost and schedule variance thresholds have been tripped, variance analysis reports (VARs) can be generated in a custom-designed hierarchical user portal. This portal allows generation of variance analysis reports by month from present to as far back as contract start. Variance analysis reports may be generated in bulk for all control accounts in an earned value project (that meet the previously mentioned criteria) and then grouped by control account manager for streamlined review by project controls. Upon generation, e-mails may be automatically sent to the responsible control account managers and a workflow may be triggered requiring project controls approval of control account manager explanations for variance.

5. Streamlined organization of finalized earned value management documentation where, at step 320, finalized EVM documentation is organized in a streamlined manner. At the end of each workflow process (currently this includes contract brief, work authorization, baseline change request, and variance analysis reporting), approved documents may be automatically finalized, locked down, and stored in program-specific document repositories. These repositories may be used as part of the control account manager notebooks that provide access and organization of control account-related information throughout the life-cycle of the project/program. The method ends at 322.

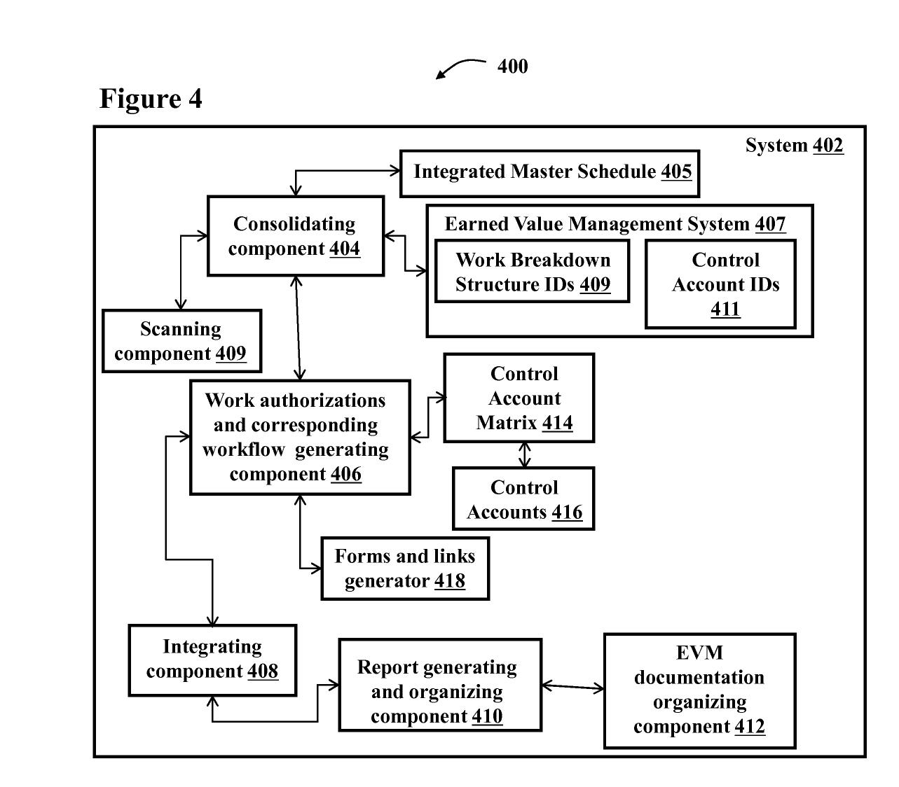

FIG. 4 illustrates an embodiment 400 of a system 402 for implementing the present invention having a consolidating component 404 for consolidating control accounts between an integrated master schedule 405 and an earned value management system 407. System 402 allows for scanning, by scanning component 409 and may have an integrated master schedule 405 for work breakdown structure ids 409 that correspond to control account ids 411 in the earned value management system 407. This may include both a direct match and all work breakdown structure sub-levels. For sub-levels, early start and late finish dates are rolled up to the control account level to provide an accurate period of performance for the control account. All accounts are listed in a custom-designed matrix/user portal for the purpose of streamlined work authorization.

System 402 further may have a work authorizations and corresponding workflow component 406. Using the system and method of the present invention, project controls managers can scan through a control account matrix 414 (also called the “work authorization document center”) to select control accounts 416 for which work should be authorized. With the click of a button, electronic work authorization forms may be automatically generated and links to these forms may be sent to the responsible control account managers by forms and links generator 418.

System 402 further may have an integrating component 408 for integrating baseline change requests and follow-on work authorizations. A report generating and organizing component 410 generates and organizes reports based on a combination of the control accounts for which work authorization has been approved and whether or not their monthly and cumulative cost and schedule variance thresholds have been tripped, variance analysis reports (VARs) can be generated in a custom-designed hierarchical user portal. Earned value management documentation organizing component 412 organizes the earned value management documentation in a streamlined fashion at the end of each workflow process (currently this includes contract brief, work authorization, baseline change request, and variance analysis reporting), approved documents may be automatically finalized, locked down, and stored in program-specific document repositories. These repositories may be used as part of the control account manager notebooks that provide access and organization of control account-related information throughout the life-cycle of the project/program.

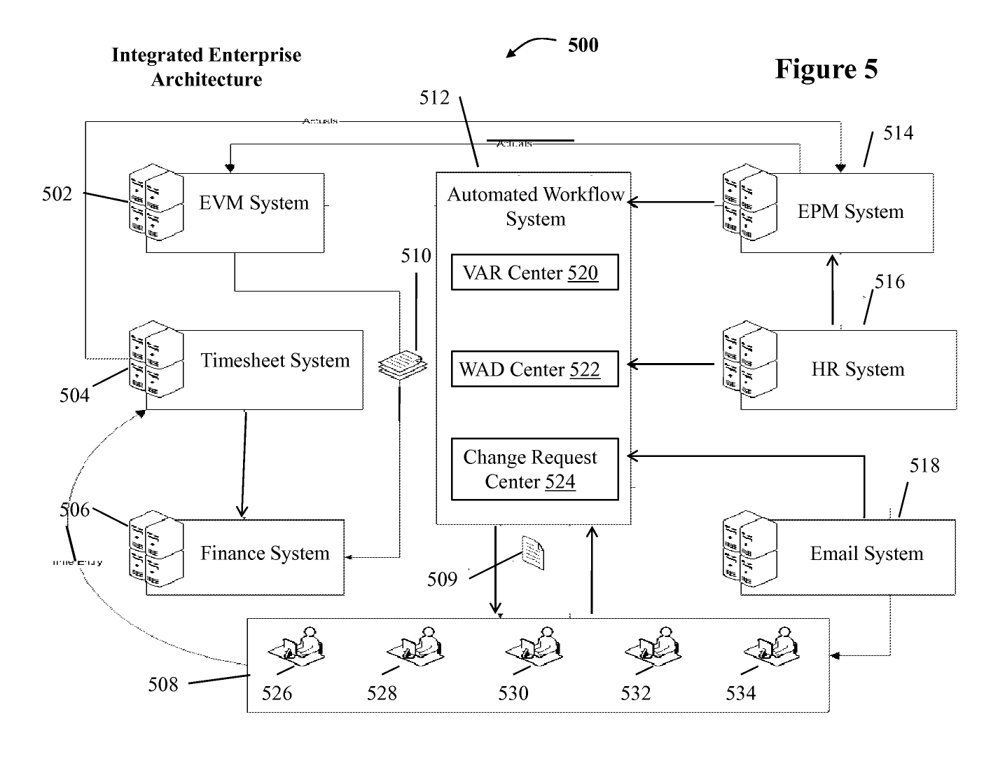

FIG. 5 illustrates an embodiment of the system 500 of the present invention having an earned value management (EVM) system 502 that may support Deltek Cobra or other systems earned value management software. Deltek Cobra is an earned value management software offered by Deltek, Inc. EVM system 502 may send financial documents 510 to a finance system 506. System 500 may further have a timesheet system 504 connected to both an EPM system 514 and multiple parties 508, such as project resource 526, control account manager (CAM) 528, project controls 530, project functional manager 532 and contract manager 534. Timesheet system 504 may receive time entry information from multiple parties 508 and can feed that information to the finance system 506 and to the EPM system 514. Enterprise Project Management (EPM), in broad terms, is the field of organizational development that supports organizations in managing integrally and adapting themselves to the changes of a transformation. In recent years, with general adoption of (IT) governance practices, Enterprise Project Management has become more specific: whereas in the 1990s focus was generally on the management of the single project, in the subsequent decade the focus lay more on the fact that a project is likely to not be the only one in the enterprise. The project co-exists with many other projects in the enterprise, or may be part of one or more programs. It may utilize (human) resources that are shared among other projects. EPM system 514 may have project server software, OpenPlan, and Primavera or other project planner software and can feed project planning information, such as scheduling information, to an automated workflow system 512 that may have a VAR center 520, a WAD center 522 and a change request center 524. OpenPlan is a trademark of Deltek, Incorporated and Primavera is a trademark of Oracle Corporation. An HR system 516 may feed user and project information to the automated workflow system 512 and to EPM system 514. An email system 518 may feed information, workflow notifications, to multiple parties 508 received from automated workflow system 512. Multiple parties 508 may communicate automated workflow system 512 by sending and receiving such files such as contract briefs, WADs, and VARs 509 to be fed into Change request center 524, WAD center 522 and VAR center 520.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for automating consolidation of data for reporting purposes, decreasing manual user intervention, and automating the generation of earned value management documentation custom designed matrix in a system, the method comprising:
consolidating control accounts between an integrated master schedule and an earned value management system;
automatically generating work authorizations and corresponding workflow;
integrating baseline change requests and follow-on work authorization;
generating and organizing, in a hierarchical manner, variance analysis reports; and
organizing, in a streamlined manner, finalized earned value management documentation.

2. The method as defined in claim 1 further comprising scanning the integrated master schedule for work breakdown structure identifiers that correspond to control account identifiers in the earned value management system.

3. The method as defined in claim 2 further comprising automatically generating electronic work authorization forms, linking the electronic work authorization forms and sending the electronic work authorization forms.

4. The method as defined in claim 3 further comprising automatically pulling in budget data from the earned value management system as well as period of performance data into the electronic work authorization forms.

5. The method as defined in claim 4 further comprising guiding project controls through the process of revising and authorizing work via the earned value management system and workflow system, or automatically generating a new “incremented” entry in a control account matrix for additional work and listing each revision of an existing control account in the control account matrix along with its baseline change request number.

6. The method as defined in claim 5 further comprising generating variance analysis reports in a custom-designed hierarchical user portal based on a combination of the control accounts for which work authorization has been approved and whether or not monthly and cumulative cost and schedule variance thresholds of the control accounts have been tripped.

7. The method as defined in claim 6 further comprising automatically finalizing, locking down, and storing process approved documents in program-specific document repositories at the end of each workflow.

8. A system for automating consolidation of data for reporting purposes, decreasing manual user intervention, and automating the generation of earned value management documentation custom designed matrix in a system, the system comprising:
a consolidating control accounts component for consolidating control accounts between an integrated master schedule and an earned value management system;
a work authorizations and corresponding workflow generating component for automatically generating work authorizations and corresponding workflow;
an integrating component for integrating baseline change requests and follow-on work authorization;
a report generating and organizing component for generating and organizing, in a hierarchical manner, variance analysis reports; and
an earned value management documentation organizing component for organizing, in a streamlined manner, finalized earned value management documentation.

9. The system as defined in claim 8 further comprising a scanning component for scanning the integrated master schedule for work breakdown structure identifiers that correspond to control account identifiers in the earned value management system.

10. The system as defined in claim 9 further comprising a forms and links generator for automatically generating electronic work authorization forms linking the electronic work authorization forms and sending the electronic work authorization forms.

11. The system as defined in claim 10 further comprising a control account matrix for storing additional work and listing each revision of an existing control account in the control account matrix along with its baseline change request number.

12. A computer program product embodied in a computer readable medium for operating in a system comprising a processing unit, a memory, a bus, input/output interfaces, an application, the computer program product for implementing a method in a system for automating consolidation of data for reporting purposes, decreasing manual user intervention, and automating the generation of earned value management documentation custom designed matrix, the method comprising:
consolidating control accounts between an integrated master schedule and an earned value management system;
automatically generating work authorizations and corresponding workflow;
integrating baseline change requests and follow-on work authorization;
generating and organizing, in a hierarchical manner, variance analysis reports; and
organizing, in a streamlined manner, finalized earned value management documentation.

13. The computer program product as defined in claim 12 wherein the method further comprises scanning the integrated master schedule for work breakdown structure identifiers that correspond to control account identifiers in the earned value management system.

14. The computer program product as defined in claim 13 wherein the method further comprises automatically generating electronic work authorization forms, linking the electronic work authorization forms and sending the electronic work authorization forms.

15. The computer program product as defined in claim 14 wherein the method further comprises automatically pulling in budget data from the earned value management system as well as period of performance data into the electronic work authorization forms.

16. The computer program product as defined in claim 12 wherein the method further comprises guiding project controls through the process of revising and authorizing work via the earned value management system and workflow system, or automatically generating a new “incremented” entry in a control account matrix for additional work and listing each revision of an existing control account in the control account matrix along with its baseline change request number.

17. A method for deploying a computing infrastructure comprising integrating computer-readable code into a computing system, wherein the code in combination with the computing system is capable of performing a process for automating consolidation of data for reporting purposes, decreasing manual user intervention, and automating the generation of earned value management documentation custom designed matrix, the process comprising:
consolidating control accounts between an integrated master schedule and an earned value management system;
automatically generating work authorizations and corresponding workflow;
integrating baseline change requests and follow-on work authorization;
generating and organizing, in a hierarchical manner, variance analysis reports; and
organizing, in a streamlined manner, finalized earned value management documentation.

18. The method as defined in claim 17 wherein the process further comprises scanning the integrated master schedule for work breakdown structure identifiers that correspond to control account identifiers in the earned value management system.

19. The method as defined in claim 18 wherein the process further comprises automatically generating electronic work authorization forms, linking the electronic work authorization forms and sending the electronic work authorization forms.

20. The method as defined in claim 19 wherein the process further comprises automatically pulling in budget data from the earned value management system as well as period of performance data into the electronic work authorization forms.
